(19) United States
(12) Patent Application Publication
(10) Pub. No.: US 2015/0284866 A1
(43) Pub. Date: Oct. 8, 2015

(54) CONTACT ELEMENT

(71) Applicant: HARTING KGAA, Espelkamp (DE)

(72) Inventors: Alexander Meyerovich, Espelkamp (DE); Frank Brode, Berlin (DE)

(21) Appl. No.: 14/430,364

(22) PCT Filed: Jul. 31, 2013
(86) PCT No.: PCT/DE2013/100280

§ 371 Date: Mar. 23, 2015

(30) Foreign Application Priority Data
Sep. 26, 2012 (DE) 10 2012 109 057.2

(51) Int. Cl. C25D 5/14; C25D 3/48; C25D 7/00; C25D 3/56; H01R 43/16; C25D 5/34; C25D 5/48; B32B 15/01; H01R 13/03; C25D 3/12; C25D 3/62

(52) U.S. Cl. CPC C25D 5/14; C25D 3/12; C25D 3/48; C25D 7/00; C25D 3/562; C25D 3/62; C25D 5/34; C25D 5/48; B32B 15/01; H01R 13/03; H01R 43/16

(57) ABSTRACT

The invention relates to a method for manufacturing electrical contact elements, wherein the contact element is substantially made from a base body, wherein the base body is subjected to the following method steps in the order listed:
a. degreasing the surface, for example by cold degreasing and/or hot degreasing and/or electrolytic degreasing,
b. washing in order to remove any present chemical residues,
c. activating the surface,
d. depositing a nickel layer,
e. further washing in order to remove any present chemical residues,
f. depositing a nickel layer,
g. further washing in order to remove any present chemical residues,
h. depositing a gold layer or a gold alloy.

The invention relates to an electrical contact element according to the preamble of claim 7 and a method for manufacturing such a contact element according to the preamble of claim 1.

Such contact elements are frequently used in insulating bodies of plug-in connectors. An electrical conductor is electrically connected to the contact element, for example using the so-called crimping technique. Contact elements may be implemented as pin or socket contacts.

DE 699 17 7620 T2 shows an aqueous electrolyte bath for the electrolytic deposition of a metal iron-tungsten alloy. In principle, gold or a gold alloy may be deposited onto such an alloy.

DE 41 18 416 A1 shows a galvanic process for coating pre-treated metal bodies with gold. In such a process, a pulse current is used in order to avoid the formation of passive layers on the metal bodies.

A galvanic process with a pulse current is very complicated to control and bears a significant source of errors. Under certain circumstances, large numbers of scrap may be produced.

It is the object of the invention to propose a galvanic gold-plating method that is simple to carry out and provides high-quality coatings.

The object is achieved by means of a method having the characterising features of claim 1.

Advantageous embodiments of the invention are set out in the dependent claims.

Contact elements are comprised of a metal base body that may either be milled from solid material or may be punched out of a flat metal sheet using punching technology. The base bodies are frequently present either as bulk material or as strip material.

It has been found that either brass or bronze is particularly advantageous as base body material and that different layers can easily be galvanically deposited onto such bodies.

It is known to a person skilled in the art how to feed base bodies present in the form of bulk material or of strip material to a galvanic process for plating.

In a first method step (a), the base bodies are degreased. To this end, an electrolytic degreasing process is advantageously chosen. Alternatively, cold degreasing, hot degreasing or a combination of different degreasing methods may be chosen.

In a subsequent method step (b), the electrolytically degreased base bodies are washed, preferably using distilled water, in order to remove any chemical residues that may be present.

Subsequently, in a further method step (c), the surface of the degreased and washed base bodies is activated. To this end, the so-called nickel strike method is preferably used. This method is well known to a person skilled in the art. Instructions for this method are available for example on the internet from the company RIAG Oberflächentechnik AG.

In a further method step (d), a nickel alloy is galvanically deposited onto the nickel layer. In a subsequent method step (e), the initially coated base body is washed again.

In a subsequent method step (f), a nickel alloy is galvanically deposited onto the nickel layer. Advantageously, this is a nickel-tungsten or a nickel-molybdenum or a nickel-cobalt or a nickel-tin alloy. These nickel alloys are particularly suitable for depositing gold or a gold alloy. Subsequently, the base body thus treated is washed again in a subsequent method step (g).

In a method step (h), a gold layer or a gold alloy is now galvanically deposited onto the base body prepared in method steps (a) to (g).

It is advantageous to wash the above-described gold-plated contact elements for the last time (method step (i)) and subsequently to dry them (method step (j)) before using them.

Advantageously, the electroplating processes described above are carried out in a direct current process. Such a process is simple to control and therefore only results in few scrap parts.

It is particularly advantageous to deposit the nickel alloy coating in a direct current process. This results in a particularly smooth nickel alloy coating, which in turn is the basis for a particularly smooth gold or gold alloy coating, even if the gold or gold alloy coating is deposited using a so-called pulse current method.

By using the method introduced here, gold alloy surfaces having a mean roughness of less than 0.1 micrometres (μm) may be achieved. Contact elements having a low surface roughness enable a large number of mating cycles. Moreover, the low roughness reduces friction, as a result of which the rate of wear of the contact surface (the gold layer or the gold alloy layer) is slowed down.

The finished contact element manufactured using the above method comprises a metallic base body that is preferably made from brass or bronze. The base body has a nickel coating deposited thereon that has a thickness of 0.2 micrometres (μm) up to a maximum of 3 micrometres (μm), particularly preferably however a thickness of 0.2 μm to a maximum of 1 μm. This nickel coating in turn is covered with a nickel alloy that also has a thickness of 1 micrometre (μm) up to a maximum of 3 micrometres (μm). Finally, a gold layer or a gold alloy layer is deposited that has a thickness of approx. 1 micrometre (μm) and a mean Ra roughness of 0.1 micrometre (μm) or less.

Preferably, the hardness of the nickel alloy layer (second layer) is greater than the hardness of the base body material and/or of the nickel layer deposited thereon (first layer). As a result, a very thin gold or gold alloy layer is sufficient.

In an advantageous embodiment, the electrical resistance of the second layer is smaller than the electrical resistance of the base body and/or of the first layer. As a result, a very thin and smooth galvanic gold deposition or gold alloy deposition is facilitated. It is particularly advantageous if the electrical resistance of the second layer is between 15 and 30 milliohm (mΩ).

### EMBODIMENT EXAMPLE

An embodiment example of the invention is shown in the drawings and will be explained in more detail below.

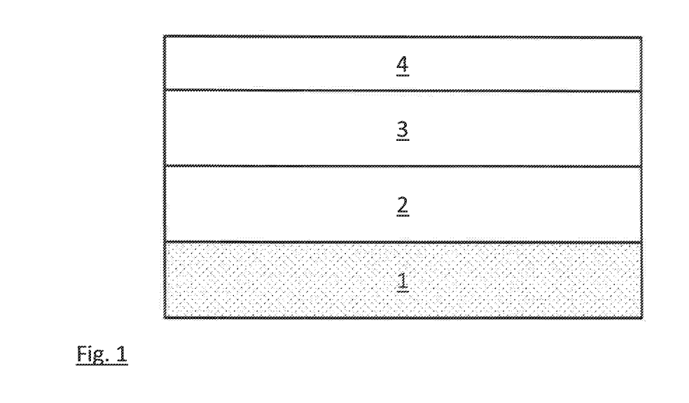

FIG. 1 shows a diagram of a body provided with different galvanic coatings.

The base body 1 is made from steel, brass or bronze. The shape of the base body 1 already substantially corresponds to the shape of a finished contact element. The contact elements may be pin or socket contacts, but also insulation displacement contacts.

A first layer 2 is galvanically deposited onto the base body. This is a nickel layer. The first layer has a layer thickness between one and three micrometres (0.2-3 μm). Onto this first layer 2, a second layer 3 is deposited. This is a nickel alloy. The nickel alloy has a thickness between one and three micrometres (1-3 μm). Finally, a gold layer or gold alloy layer 4 is deposited onto the nickel alloy layer. This final layer has a thickness between 0.1 and 2 micrometres (0.1-2 μm) or less and a mean Ra roughness of 0.1 micrometres (0.1 μm) or less.

### LIST OF REFERENCE NUMERALS

1 Base body

2 First layer, nickel layer

3 Second layer, nickel alloy layer

4 Final layer, gold layer or gold alloy layer

1. A method for manufacturing electrical contact elements, wherein the contact element is substantially made from a base body, wherein the base body is subjected to the following method, steps in the order listed:
a. degreasing the surface, for example by cold degreasing and/or hot degreasing and/or electrolytic degreasing,
b. washing in order to remove any present chemical residues,
C. activating the surface,
d. depositing a nickel layer,
e. further washing for removing any present chemical residues,
f. depositing a nickel layer,
g. further washing for removing any present chemical residues,
h. depositing a gold layer or a gold alloy.

2. The method for manufacturing an electrical contact element according to claim 1,
characterised in that
the following further method steps follow after method step h:
i. further washing in order to remove any present chemical residues,
j. drying.

3. The method for manufacturing an electrical contact element according to claim 1,
characterised in that
the activation of the surface in method step b is realised by means of a nickel strike method.

4. The method for manufacturing an electrical contact element according to claim 1,
characterised in that
the nickel alloy in method step f is a nickel-tungsten or a nickel-molybdenum or a nickel-cobalt or a nickel-tin alloy.

5. The method manufacturing an electrical contact element according to claim 1,
characterised in that
the base body is made from steel or a copper alloy, for example from brass or bronze.

6. The method for manufacturing an electrical contact element according to claim 1,
characterised in that
the alloy in method step d and/or f and/or h is deposited using a direct current method.

7. An electrical contact element,
which is formed from a base body made from a copper alloy such as for example brass or bronze,
wherein the base body is coated with a first layer, a nickel layer having a layer thickness between 0.2 and 3 μm,
wherein the first layer is coated with a second layer, a nickel alloy having a layer thickness between 0.2 and 3 μm,
wherein the second layer is coated with a gold layer or a gold alloy.

8. The electrical contact element according to claim 7,
characterised in that
the gold layer or a gold alloy layer has a layer thickness between 0.1 and 2 micrometres (μm).

9. The electrical contact element according to claim 7,
characterised in that
the gold layer or the gold alloy layer has a mean Ra roughness of 0.1 μm or less than 0.1 μm.

10. The electrical contact element according to claim 7,
characterised in that
the hardness of the second layer is greater than the hardness of the base body and/or of the second layer.

11. The electrical contact element, according to claim 7,
characterised in that
the electrical resistance of the second layer is less than the electrical resistance of the base body and/or of the first layer.

12. The electrical contact element according to claim 7,
characterised in that
the electrical resistance of the second layer is between 15 and 30 mΩ.
